(19) United States
(12) Patent Application Publication
(10) Pub. No.: US 2022/0143705 A1
(43) Pub. Date: May 12, 2022

(54) DETERMINING A VOLUME OF BINDER TO BE APPLIED TO A VOXEL LOCATION

(71) Applicant: Hewlett-Packard Development Company, L.P., Spring, TX (US)

(72) Inventors: Sergio Puigardeu Aramendia, Sant Cugat del Valles (ES); Macia Sole Pons, Corvallis, OR (US)

(73) Assignee: Hewlett-Packard Development Company, L.P., Spring, TX (US)

(21) Appl. No.: 17/417,743

(22) PCT Filed: Jul. 23, 2019
(86) PCT No.: PCT/US2019/042911

§ 371 Date: Jun. 23, 2021

(51) Int. Cl. B22F 10/85; B22F 10/14; B29C 64/165; B29C 64/393; B33Y 10/00; B33Y 30/00; B33Y 50/02

(52) U.S. Cl. CPC B22F 10/85; B22F 10/14; B29C 64/165; B29K 2007/00; B33Y 10/00; B33Y 30/00; B33Y 50/02; B29C 64/393

(57) ABSTRACT

A method comprises receiving data representing a 3D object model. The 3D object model is for use in generating a 3D object in a build chamber by forming a plurality of successive layers. Each layer is formed by providing a layer of build material and applying a volume of a binder agent to a plurality of voxel locations of the layer of the build material. The volume of the binder agent to be applied to each voxel location is based on the volume of binder agent to be applied to proximate voxel locations of the 3D object.

### BACKGROUND

A three-dimensional (3D) printer may generate a 3D object by forming a plurality of successive layers, Each layer may be formed by providing a layer of powdered build material, and selectively applying a binder agent to locations within the layer, based on a received 3D object model. The binder agent is then activated, for example by the application of heat or UV light to cause the powder to solidify. When all the layers of the object have been printed, any excess build material is then removed from the 3D object. In examples where the build material is a metal powder, the object may be subsequently sintered.

### BRIEF DESCRIPTION OF DRAWINGS

FIG. 1 is a schematic block diagram of an example 3D printer;

FIG. 2 is a flowchart of an example method;

FIG. 3 is a schematic diagram illustrating the axes of an example 3D model; and

FIG. 4 is a schematic block diagram of an example computer-readable storage medium.

### DESCRIPTION

In 3D printing, a binder agent may be applied to selected locations in a layer of build material. The locations correspond to voxels in a 3D object model of the object being formed, and are hereinafter referred to as voxel locations.

The binder agent, once activated, may solidify and form a matrix enclosing the particles of the powder within the current layer. Furthermore, a proportion of the binder agent, which may be liquid, migrates downward into the previously-printed layers below the current layer, thereby causing the particles of the powder within the current layer to be secured to the previous layer. In order to obtain a 3D-printed object with good strength qualities, the amount of binder agent applied may be increased. However, if too much binder agent is applied, excess agent may migrate to the bottom of the build chamber and accumulate, causing unwanted effects, such as the unwanted solidification of build material, resulting in a print defect.

Examples of the disclosure provide a method, a non-transitory machine-readable storage medium and a 3D printer, in which the volume of binder applied to each voxel location of the 3D object is calculated based on the volume of binder to be applied to proximate voxel locations of the 3D object.

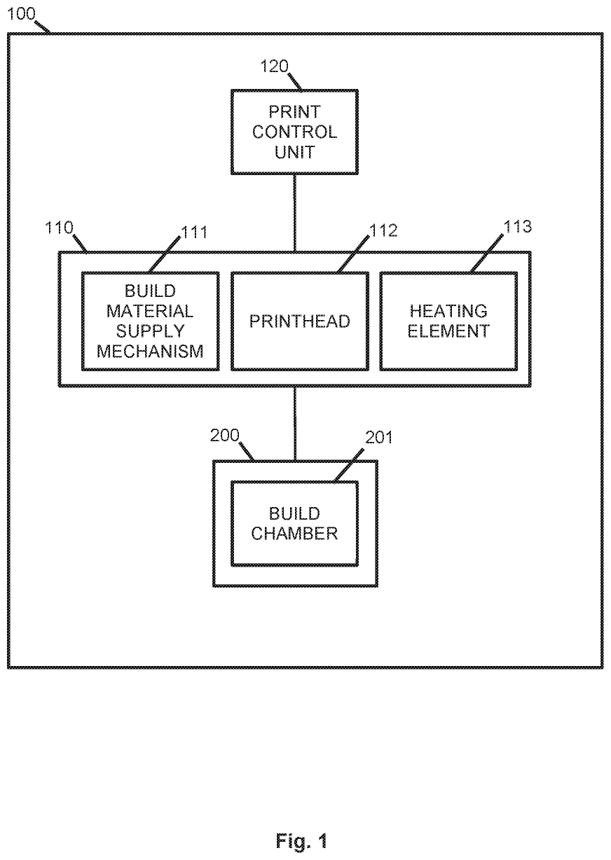

FIG. 1 shows an example 3D printer 100. The 3D printer 100 comprises a print unit 110 and a print control unit 120. The 3D printer 100 is also configured to receive a build unit 200. The build unit 200 may be a modular unit insertable into the 3D printer 100. The build unit 200 comprises a build chamber 201, in which the formation of a 3D object takes place.

The print unit 110 comprises any suitable elements to carry out 3D printing with the build unit 200. The print unit 110 may for example comprise a build material supply mechanism 111 to deliver build material to the build chamber 201. For example, the build material supply mechanism 111 may be to supply a layer of build material for forming a layer of the 3D object. For example, the build material supply mechanism 111 may supply a build material comprising a metal powder, for example a stainless steel powder or a copper powder.

The print unit 110 comprises a printhead 112 to selectively dispense a volume of a binder agent to locations of the layer of build material corresponding to a layer of a 3D object to be generated. The printhead 112 is configured to vary the volume of binder applied to each voxel location. In other words, the printhead 112 may supply different volumes of binder to different voxel locations of the 3D object, as will be discussed in more detail below. In one example, the binder agent is a liquid. In one example, the binder agent comprises latex.

The print unit 110 may further comprise a heating element 113 to solidify the dispensed binder agent. In alternative examples, the binder agent may be curable by UV light, in which case the print unit 110 may comprise a UV light source for curing the binder agent.

The print control unit 120, which may comprise a processor and a memory, is to control the print unit 110 in order to generate the 3D object in the build chamber 201. The print control unit 120 may receive data representing a 3D object model, and use the 3D object model to control the printhead 112 to dispense binder agent at voxel locations so as to form the 3D object. Furthermore, the print control unit 120 may determine an amount of binder agent to be applied at each voxel location, based on an amount of binder agent to be applied at proximate voxel locations.

In use, the print control unit 120 controls the build material supply mechanism 111 to deliver a layer of build material to the build chamber 201. Next, the print control unit 120 controls the printhead 112 to apply binder to voxel locations in order to form the 3D object. The volume of binder applied is varied based on an amount of binder agent to be applied at proximate voxel locations. After binder has been applied to the layer, the heating element 113 heats the build chamber 201 to solidify or cure the binder.

Once the layer is formed, the process is repeated, so as to successively form layers of the 3D object. Once the 3D object is fully formed, it is removed from the build chamber, and any excess build material is removed. If the build material is a metal powder, the 3D object may then be sintered.

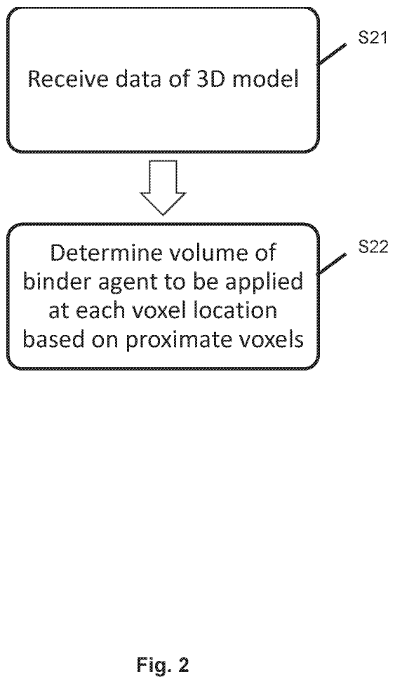

FIG. 2 shows an example method of determining a volume of binder agent to be applied to a voxel location.

In block S21, data representing a 3D object model is received. The data may take the form of a suitable data file.

In block S22, the volume of the binder agent to be applied to each voxel location is determined. The volume is determined based on the volume of binder agent to be applied to proximate voxel locations of the 3D object.

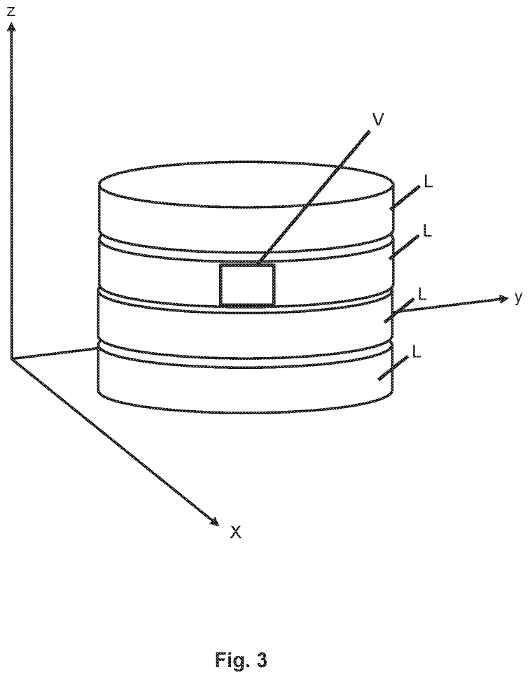

As shown in FIG. 3, a voxel location V can be considered a point in 3D space, with the X and Y axes being perpendicular horizontal axes, and the Z axis being the vertical axis. Accordingly, proximate voxel locations in the X and Y directions are within the same layer L as the voxel location V, whereas proximate voxel locations in the Z direction are in a different layer L.

In one example, a default volume of binder is varied, based on the effect of binder agent to be applied to proximate voxel locations. The default volume may be set in advance, for example according to user preferences.

In one example, the volume of binder agent to be applied at a given voxel location v is calculated according to the following formula:

volume of hinder(v)=default volume−c*neighbour_effect(v)

where c is a constant, and the neighboureffect represents the effect of the binder agent applied to proximate voxel locations. The constant c may be set according to

In one example, the neighbour effect is calculated based on proximate voxel locations in the X and Y directions. Accordingly, the volume of binder applied at a target voxel location is varied based on the volume of binder applied at proximate voxel locations within the same layer of the build material.

In one example, the neighbour effect is calculated based on proximate voxel locations in the Z direction. Accordingly, the volume of binder at a voxel location applied is varied based on the volume of binder applied at a proximate voxel location within a different layer of the build material. For example, the volume of binder may be varied based on the volume of binder applied to voxel locations in layers to be printed above the target voxel location, wherein a portion of the binder applied may migrate to the target voxel location for example by gravity.

In one example, the neighbour effect is calculated according to the following formula:

$$neighbour\_effect ( v ) = {\sum }_{k = 0}^{n} ( {\sum }_{i = 0}^{m} xyBlur ( i ) * count\_of \_voxels \_at \_distance ( i ) ) * zBlur ( k )$$

n is the maximum distance in the Z direction being taken into account m is the maximum distance in the XY directions being taken into account.

xyBlur is a function that represents the weight given to a voxel location at a given distance from the target voxel location v in the X or Y direction. The xyBlur therefore represents a binder penetration value in the X or Y direction. That is to say, the value returned by xyBlur reflects the amount of binder that is likely to reach the target voxel location from a voxel location at the given distance away. Accordingly, the xyBlur provides a weighting such that more proximate voxel locations in the XY direction have a greater influence over the target voxel location when compared to less proximate voxel locations.

In one example, the xyBlur for a particular distance varies depending on the build material. For example, a more porous build material may permit more of the binder to migrate therethrough. In one example, the xyBlur may vary depending on the time taken to form a layer of the 3D object. For example, if the layer time is longer, more of the binder may migrate toward the target voxel. In one example, the xyBlur may vary depending on the type of binder used. For example, a less viscous binder may migrate further when compared to a more viscous binder. In one example, the xyBlur may vary depending on the amount of binder used—i.e. the default binder amount. For example, if more binder is applied, the binder may migrate further.

In one example, the xyBlur for each distance may be determined in advance. For example, for a given combination of build material, layer time, binder type, and binder amount, the xyBlur at each distance may be determined. The xyBlur may be determined for example based on laboratory experiments or computer simulations.

zBlur is a function that represents the weight given to a voxel location at a given distance from the target voxel location v in the Z direction. The zBlur therefore represents a binder penetration value in the Z direction. That is to say, the value returned by zBlur reflects the amount of binder that is likely to reach the target voxel location from a voxel location at the given distance above the target voxel location. Accordingly, the zBlur provides a weighting such that more proximate voxel locations in the Z direction have a greater influence over the target voxel location when compared to less proximate voxel locations.

In a similar manner to xyBlur, the zBlur for a particular distance varies depending on one or more of the build material, layer time, binder type, and binder amount. The zBlur may also be determined in advance in a similar manner to the xyBlur.

count_of_voxels_at_distance is a function that returns the number of voxel locations in the 3D model at a given distance from the target voxel location in the XY direction.

The following worked example illustrates the calculation of the neighbour effect. In the example, n=2 and m=3. Furthermore, the xyBlur returns the value at the corresponding index from the list [0.9, 0.7, 0.5, 0.2] and the zBlur returns the value at the corresponding index from the list [1, 0.5, 0.2]

In the current layer (k=0), there are the following number of proximate voxel locations at each distance i in the XY direction:

Number of voxel locations at distance “i=0” (direct neighbours)=3

Number of voxel locations at distance “i=1”=4

Number of voxel locations at distance “i=2”=6

Number of voxel locations at distance “i=3”->10

Accordingly, the effect caused by proximate voxel locations in the current layer is 0.9*3+0.7*4+0.5*6+0.2*10=10.5

This is then multiplied by the zBlur for k=0: 10.5*1=10.5

In the layer 1 above the target voxel location (k=1), there are the following number of proximate voxel locations at each distance i in the XY direction:

Number of voxel locations at distance “i=0”=1

Number of voxel locations at distance “i=1”=4

Number of voxel locations at distance “i=2”=8

Number of voxel locations at distance “i=3”=0

Accordingly, the effect caused by proximate voxel locations in this layer is 0.9*1+0.7*4+0.5*8+0.2*0=7.7

This is then multiplied by the zBlur for k=1: 7.7*0.5=3.85

In the layer 2 above the target voxel location (k=2), there are the following number of proximate voxel locations at each distance i in the XY direction:

Number of voxel locations at distance “i=0”=9

Number of voxel locations at distance “i=1”=5

Number of voxel locations at distance “i=2”=

Number of voxel locations at distance “i=3”=5

Accordingly, the effect caused by proximate voxel locations in this layer is 0.9*9+0.7*5+0.5*3+0.2*5=15

This is then multiplied by the zBlur for k=2: 15*0.2=3

Finally, the effect at each layers k=0 to k=2 is summed to give the neighbour_effect:
10.5+3.85+3=17.35

In the above example, the effect of voxel locations in layers above the target voxel location are taken into account in determining the volume of binder to be applied. In further examples, the effect of voxel locations below the target voxel location may also be taken into account in a similar manner. For example, it may be the case that the binder applied below the target voxel location influences the capability of the binder to migrate through the object to lower layers thereof.

In some examples, including the above example, the volume of binder agent applied to the target voxel location is calculated by counting the number of proximate voxel locations, both within the same layer as the target voxel location and in a plurality of layers above the target voxel. The number of proximate voxel locations counted may be limited by a predetermined limit distance in the XY direction and/or the Z direction, for example n and m as discussed above, so that voxel locations beyond the limit distance are not taken into account.

Subsequently, each proximate voxel location may be assigned a value based on its distance from the target voxel location. The value assigned to each proximate voxel location is reflective of the volume of binder agent it is estimated will reach the target voxel location. By summing these values, an approximation may be provided of the volume of binder likely to reach the target voxel location from the proximate voxel locations. The volume of binder agent to be applied to the target voxel location may therefore be adjusted accordingly. Therefore, the volume of binder agent applied to the target voxel is based on the volumes of binder agent to be applied to the proximate voxel locations.

For example, each voxel location in a given layer is assigned a value based on its distance from the target voxel in the XY direction, for example using the xyBlur function described above. All the XY values for a given layer may then be summed. The total of the XY values may then be multiplied by a value reflecting the distance of the given layer from the target voxel in the Z direction, for example determined using the zBlur function described above.

In one example, the method is executed by the 3D printer 100, for example the print control unit 120. However, in other examples, the method may be carried out by a separate computing device. For example, the volume of binder agent for each voxel location may be determined in pre-print software executed on the separate computing device, such that the print control unit 120 receives data representing the 3D object model, along with data representing the volume of binder agent to be applied at each location.

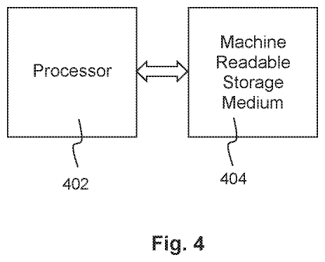

FIG. 4 shows an example non-transitory machine-readable storage medium 404 encoded with instructions executable by a processor 402. The machine-readable storage medium may comprise instructions to determine a volume of binder agent to be applied to a voxel location in a 3D object, based on a volume of binder agent to be applied to proximate voxel locations of the 3D object. In one example, the instructions may determine the volume of binder agent in accordance with any of the methods described herein.

According to the examples described herein, the volume of binder applied at each target voxel location is calculated based on proximate voxel locations. Accordingly, the binder applied to proximate voxel locations, which may migrate to the target voxel location, is accounted for. This may provide a more uniform distribution of binder throughout the 3D object, thereby improving strength characteristics. Furthermore, the likelihood of excess binder migrating to the bottom of the 3D object and solidifying to form a defect or distortion.

1. A method comprising:
receiving data representing a 3D object model, the 3D object model for use in generating a 3D object in a build chamber by forming a plurality of successive layers, wherein each layer is formed by providing a layer of build material and applying a volume of a binder agent to a plurality of voxel locations of the layer of the build material, and
determining the volume of the binder agent to be applied to each voxel location based on the volume of binder agent to be applied to proximate voxel locations of the 3D object.

2. The method of claim 1, wherein the build material comprises a metal powder.

3. The method of claim 1, wherein the binder agent comprises latex.

4. The method of claim 1, wherein the volume of binder agent applied to each voxel location is varied based on a binder penetration value, the binder penetration value representing a degree to which the binder agent permeates through the build material in use.

5. The method of claim 4, wherein the binder penetration value is calculated based on a type of the build material, a time taken to form each layer of the 3D object, and a type of the binder agent used.

6. The method of claim 1, wherein the proximate voxel locations are voxel locations within the same layer of the 3D object.

7. The method of claim 1, wherein the proximate voxel location are voxel locations in another layer of the 3D object.

8. The method of claim 1, comprising varying the volume of binder agent applied to each voxel location based on the volume of binder agent to be applied to proximate voxel locations, such that the volume of binder agent applied to more proximate voxel locations is weighted higher that the volume of binder agent applied to less proximate voxel locations.

9. The method of claim 1, comprising determining the volume of the binder agent to be applied to each voxel location based on the volume of binder agent to be applied to proximate voxel locations of the 3D object by:
assigning a value to each of the proximate voxel locations, wherein the value reflects a volume of binder agent that will reach the voxel location from the proximate voxel location;
summing the assigned values; and
reducing a default volume of binder agent to be applied to the voxel location based on the sum of the assigned values.

10. A non-transitory machine-readable storage medium encoded with instructions executable by a processor, the machine-readable storage medium comprising:
instructions to determine a volume of binder agent to be applied to a voxel location in a 3D object, based on a volume of binder agent to be applied to proximate voxel locations of the 3D object.

11. The non-transitory machine-readable storage medium of claim 10, further comprising:
instructions to assign a value to each of the proximate voxel locations, wherein the value reflects a volume of binder agent that will reach the voxel location from the proximate voxel location;
instructions to sum the assigned values; and
instructions to reduce a default volume of binder agent to be applied to the voxel location based on the sum of the assigned values.

12. A three-dimensional printer comprising:
a printhead to dispense binder agent to a location of a layer of build a material of a build volume;
a controller to:
determine a volume of binder to be dispensed to the location based on volumes of binder dispensed to proximate locations of the build volume; and
control the printhead to dispense the determined volume of binder.

13. The three-dimensional printer of claim 12, wherein the build material comprises a metal powder.

14. The three-dimensional printer of claim 12, wherein the binder agent comprises latex.

15. The three-dimensional printer of claim 12, wherein the controller is to:
assign a value to each of the proximate voxel locations, wherein the value reflects a volume of binder agent that will reach the voxel location from the proximate voxel location;
sum the assigned values; and
reduce a default volume of binder agent to be applied to the voxel location based on the sum of the assigned values.
